(19) United States
(12) Patent Application Publication
(10) Pub. No.: US 2022/0255285 A1
(43) Pub. Date: Aug. 11, 2022

(54) ALL-FIBER WIDELY TUNABLE ULTRAFAST LASER SOURCE

(71) Applicants: OFS Fitel, LLC, Norcross, GA (US); TOPTICA Photonics AG, Gräfelfing (DE)

(72) Inventors: Jeffrey W Nicholson, Warren, NJ (US); Armin Zach, Gräfelfing (DE)

(73) Assignees: OFS Fitel, LLC, Norcross, GA (US); TOPTICA Photonics AG, Gräfelfing, GA (DE)

(21) Appl. No.: 17/625,763

(22) PCT Filed: Jul. 9, 2020
(86) PCT No.: PCT/US20/41464

§ 371 Date: Jan. 9, 2022

Related U.S. Application Data
(60) Provisional application No. 62/872,563, filed on Jul. 10, 2019.

(51) Int. Cl. H01S 3/11; H01S 3/00; H01S 3/067; H01S 3/23

(52) U.S. Cl. CPC H01S 3/1118; H01S 3/0092; H01S 3/0675; H01S 3/094015; H01S 3/0064; H01S 3/06712; H01S 3/06754; H01S 3/2391

(57) ABSTRACT

Disclosed herein is an all-fiber, easy to use, wavelength tunable, ultrafast laser based on soliton self-frequency-shifting in an Er-doped polarization-maintaining very large mode area (PM VLMA) fiber. The ultrafast laser system may include an all polarization-maintaining (PM) fiber mode-locked seed laser with a pre-amplifier; a Raman laser including a cascaded Raman resonator and an ytterbium (Yb) fiber laser cavity; an amplifier core-pumped by the Raman laser, the amplifier including an erbium (Er) doped polarization maintaining very large mode area (PM Er VLMA) optical fiber and a passive PM VLMA fiber following the PM Er VLMA, the passive PM VLMA for supporting a spectral shift to a longer wavelength.

### CROSS-REFERENCE TO RELATED APPLICATIONS

The present application claims priority to U.S. Provisional Patent Application Ser. No. 62/872,563 entitled “All-fiber widely tunable ultrafast laser source,” filed Jul. 10, 2019, the disclosure of which is incorporated herein by reference in its entirety.

### BACKGROUND

Embodiments of the present disclosure are generally related to ultrafast optics. The rapid-growth development of biomedical applications using ultrafast optical pulses in the visible spectral range creates a strong need for developing improved ultrafast optical technology. Ultrafast optics and imaging provide safe non-invasive techniques for diagnosis that are of interest in the biomedical community. Ultrafast optics experiments may involve ultrashort pulses as generated with mode-locked lasers. Generally, an ultrashort pulse of light is an electromagnetic pulse whose time duration is of the order of a picosecond or less.

Emerging applications in ultrafast optics require an upscaling of single spatial mode power levels directly out of the fiber. Nonlinear microscopy, two-photon polymerization, electro-optical sampling, and terahertz imaging are just a few applications that would benefit tremendously if ultrafast laser systems weren't bulky and complex.

### SUMMARY

Embodiments of the present disclosure generally relate to an all-fiber, easy to use, wavelength tunable, ultrafast laser system. Embodiments of the present disclosure may include an ultrafast laser system comprising an all polarization-maintaining (PM) fiber mode-locked seed laser with a pre-amplifier; a Raman laser comprising a cascaded Raman resonator and an ytterbium (Yb) fiber laser cavity; an amplifier core-pumped by the Raman laser, the amplifier comprising an erbium (Er) doped polarization maintaining very large mode area (PM Er VLMA) optical fiber and a passive PM VLMA fiber following the PM Er VLMA, the passive PM VLMA for supporting a spectral shift to a longer wavelength; wherein the system provides a spectral coverage starting from 1620 nm to 1990 nm. An ultrafast laser system may include a passive PM VLMA fiber and a PM Er VLMA fiber that are configured to have the same fundamental mode effective area. An ultrafast laser system may include a passive PM VLMA spiraled in a decreasing coil diameter to achieve decreasing effective area along the length of the passive PM VLMA.

### BRIEF DESCRIPTION OF THE DRAWINGS

So the manner in which the above-recited features of the present disclosure can be understood in detail, a more particular description of embodiments of the present disclosure may be had by reference to the appended drawings. It is to be noted, however, the appended drawings illustrate only exemplary embodiments encompassed within the scope of the present disclosure and are not to be considered limiting, for the present disclosure may admit to other equally effective embodiments, wherein:

FIG. 1A is a block diagram illustrating a laser system comprising an all PM fiber mode-locked seed laser, a Raman fiber laser, and a PM VLMA amplifier in accordance with embodiments of the present disclosure;

FIG. 1B is a block diagram illustrating a laser system comprising an all PM fiber mode-locked seed laser, a Raman fiber laser, and a PM VLMA amplifier in accordance with embodiments of the present disclosure;

FIG. 2A is a chart illustrating a relationship between bend diameter, effective area (Aeff), and nonlinear parameter (gamma) in accordance with embodiments of the present disclosure;

FIG. 2B is a chart illustrating a relationship between beam radius and position in accordance with embodiments of the present disclosure;

FIG. 3A is a chart illustrating the spectral tuning of output by variation of 1480 nm pump power in accordance with embodiments of the present disclosure;

FIG. 3B is an autocorrelation trace of infrared output in accordance with embodiments of the present disclosure;

FIG. 4A is a chart illustrating spectral tuning of a Second Harmonic Generation (SHG) output by variation of the pump power in accordance with embodiments of the present disclosure;

FIG. 4B is a chart illustrating average output power and pulse energy in relation to spectral tuning wavelength in accordance with embodiments of the present disclosure;

FIG. 4C is an autocorrelation trace of Second Harmonic Generation (SHG) output in accordance with embodiments of the present disclosure;

FIG. 5A is an image of immunostained fibroblasts actin cytoskeleton and myosin captured in accordance with embodiments of the present disclosure;

FIG. 5B is an image of Two-photon excited fluorescence (TPEF) of actin at Lifeact-green fluorescent protein (GFP) transfected fibroblasts captured in accordance with embodiments of the present disclosure;

FIG. 5C is a second-harmonic generation (SHG) image of mouse tendon collagen fibrils with the forward detected signal and backward detected signal captured in accordance with embodiments of the present disclosure;

FIG. 5D is a second-harmonic generation (SHG) image of organization of fibrils in high resolution without staining signal captured in accordance with embodiments of the present disclosure;

FIG. 5E is a third harmonic generation (THG) image of mouse fat tissue excited captured in accordance with embodiments of the present disclosure;

FIG. 6 is a block diagram illustrating a Coherent anti-Stokes Raman spectroscopy (CARS) laser setup in accordance with embodiments of the present disclosure;

FIG. 7A is a Sum Frequency Coherent anti-Stokes Raman spectroscopy (SF-CARS) image of mouse fat tissue captured in accordance with embodiments of the present disclosure; and

FIG. 7B is a Sum Frequency Coherent anti-Stokes Raman spectroscopy (SF-CARS) image of mouse fat tissue captured in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

The exemplary embodiments described herein disclose an all-fiber versatile laser system fitting to the needs of multimodal imaging in nonlinear microscopy, or the like. Embodiments of the present disclosure provide the flexibility to perform second-harmonic generation (SHG), third harmonic generation (THG), two-photon excited fluorescence (TPEF), and Sum Frequency Coherent anti-Stokes Raman spectroscopy (SF-CARS), or the like, with a simple setup. Having a polarization extinction ratio better than 40 dB and a M² of 1.1, a computer-controlled laser system in accordance with embodiments of the present disclosure presents a robust and compact laser source. The parameters of the present disclosure make a laser system suited for multimodal imaging in nonlinear microscopy, or the like. Technical configurations and effects of an all-fiber, easy to use, wavelength tunable, ultrafast laser based on soliton self-frequency-shifting in an Erbium (Er) doped polarization-maintaining very large mode area (PM VLMA) fiber according to the present disclosure will be clearly understood by the following detailed description provided with reference to the accompanying drawings in which exemplary embodiments of the present disclosure are illustrated.

For the purpose of simplification and clarity of illustration, a general configuration scheme will be illustrated in the accompanying drawings, and a detailed description for the feature and the technology well-known in the art will be omitted in order to prevent the discussion of exemplary embodiments of the present disclosure from being unnecessarily obscure. Additionally, components in the accompanying drawings are not necessarily drawn to scale. For example, sizes may be exaggerated in order to assist in the understanding of exemplary embodiments of the present disclosure. Like reference numerals on different drawings will denote like components, and similar reference numerals on different drawings will denote similar components but are not necessarily limited thereto.

Embodiments of the present disclosure may include an all-fiber, easy to use, wavelength tunable, ultrafast laser system. The system may include soliton self-frequency-shifting in an Er-doped polarization-maintaining large mode area (PM VLMA) fiber. For example, the system may show large spectral coverage and may be tunable over 370 nm starting at 1620 nm with an average power of up to 1.5 W that emits 120 fs short laser pulses directly out of the fusion spliced fiber without the use of bulky pulse compression optics. With an additional second-harmonic generation (SHG), the output may be subsequently frequency doubled to a wavelength range covering 800 nm up to 1000 nm and 2.5 nJ pulse energy with more than 500 mW average power and 120 fs pulse width.

Embodiments of the present disclosure may achieve higher doping levels leading to a higher gain in short fiber length. For the wavelength range around 1.5 μm covered by Er-doped fiber lasers, the availability of step-index fibers with negative and positive dispersion is a great benefit in designing all-fiber fusion spliced lasers without the use of bulky compression optics. For large mode area fibers in the 1.5 μm wavelength range, the material dispersion prevails over the waveguide dispersion and the amplification process can occur in the anomalous dispersion regime. This is beneficial for soliton pulse compression where the interplay between self-phase-modulation and anomalous dispersion compresses the pulse during its propagation along the fiber. However, for ultra-short pulses, the tight mode confinement limits the pulse peak powers of mode-locked fiber oscillators to ˜1 kW due to the nonlinear effect.

A system in accordance with embodiments of the present disclosure may comprise an Er-doped very large mode area polarization maintaining (PM VLMA) fiber in the amplifier. Starting at 1.5 μm with an Er-based fiber laser, the wavelength region from 1.6 μm up to 2 μm can conveniently be accessed by soliton self-frequency shifting (SSFS) in combination with a master-oscillator-power-amplifier (MOPA) based soliton compression amplification without the use of free space compression optics. For very short solitons, the spectrum broadens to such an extent that the longer wavelength tail experiences Raman amplification generated by the power of the shorter wavelength tail of the spectrum causing an overall spectral shift of the soliton towards longer wavelengths. This effect is strongly dependent on the pulse width because shorter soliton pulses exhibit higher peak power and a broader optical spectrum.

Multimodal imaging approaches require flexible and spectrally tunable short pulse sources in order to cover all facets of nonlinear processes. Two-photon excited fluorescence (TPEF) microscopy is widespread using Ti:Sa lasers with a spectral coverage between 700 nm and 1000 nm. Deep-tissue in vivo imaging employs third harmonic generation (THG) taking advantage of the low attenuation window in tissue starting from 1650 nm up to 1850 nm. In general, the entire spectral range from 680 nm up to 1650 nm is interesting for multimodal imaging that optical parametric oscillator (OPO) systems are able to address. These laser systems rely on an extremely complicated and sensitive free space setup.

Using fiber lasers instead, the spectral window for THG around 1.65 μm to 1.85 μm can be easily accessed by SSFS starting from an Er-doped fiber laser source. With a small extension of this window, the tunable wavelength can be frequency doubled to cover 800 nm to 1000 nm required for TPEF microscopy. The exemplary embodiments demonstrate a wavelength tunable all-fiber laser system based on SSFS using a MOPA approach with a PM VLMA fiber amplifier for ultrashort pulses followed by a piece of passive PM VLMA fiber. A design without the passive PM VLMA fiber at the output may generate 21 nJ pulse energy and 86 fs pulse width, tunable up to 1650 nm. With the tunability extended up to 2000 nm with an increased energy of more than 25 nJ followed by a compact tunable second harmonic generation stage, embodiments of the present disclosure may convert the output into a short pulse with a spectral range between 800 nm and 1000 nm. In combination with a temporally synchronized second output at 1050 nm, a two-color two-photon (2C2P) excitation microscopy as well as Coherent Anti-Stokes Raman Scattering (CARS) microscopy may have an extremely wide spectral coverage ranging from 500 cm-1 up to 3100 cm-1, addressing not only the Raman fingerprint region but also the aromatic CH groups, the aliphatic CH2 and the aliphatic CH3 groups.

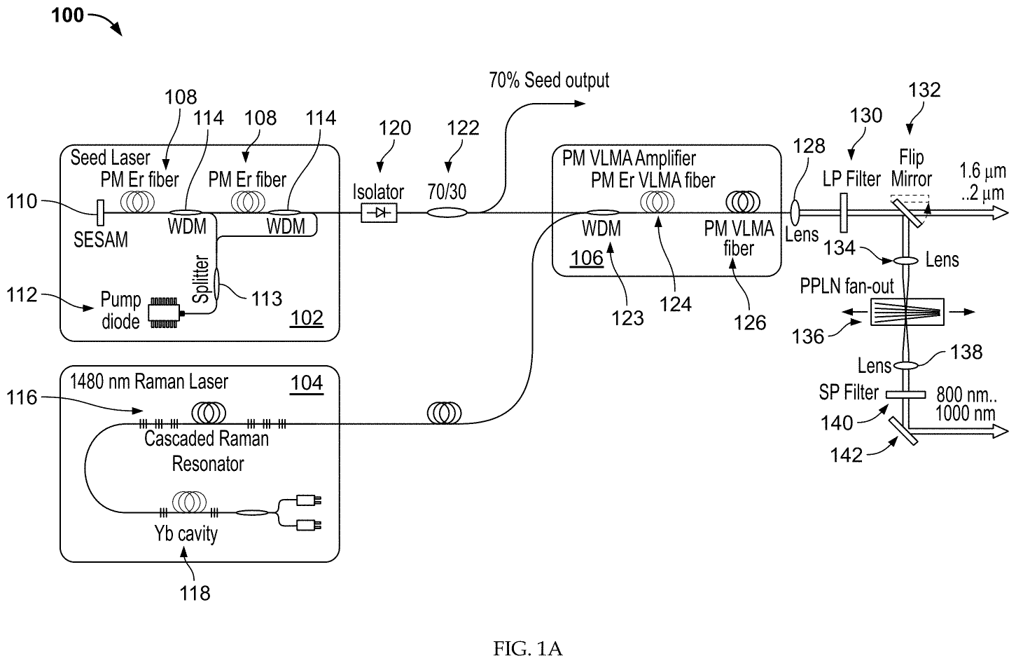

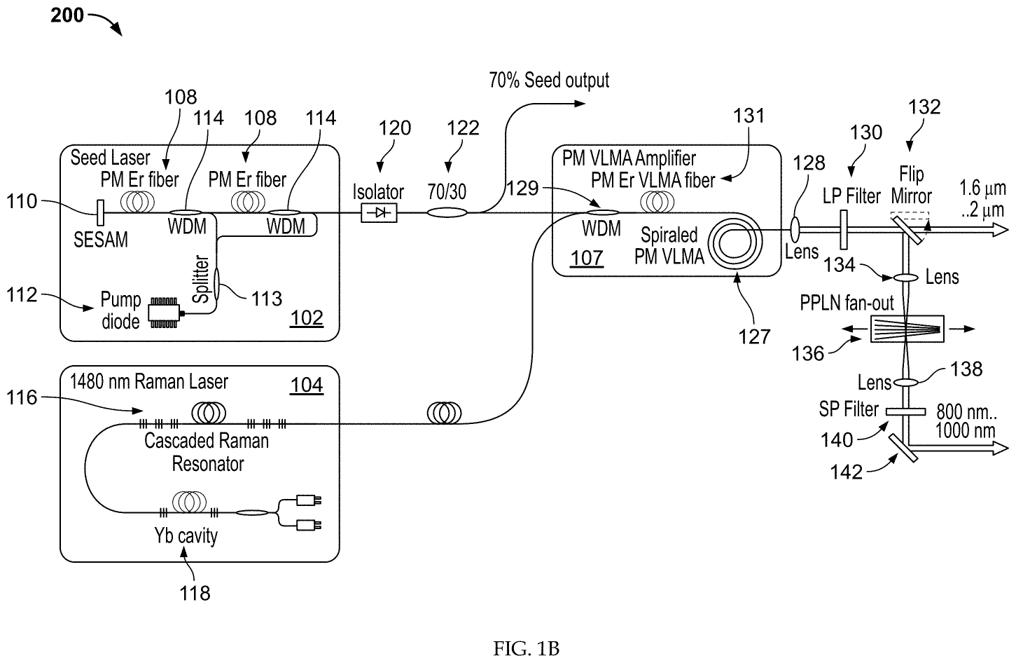

Referring now to FIG. 1A, a block diagram is provided illustrating a laser system 100 comprising an all PM fiber mode-locked seed laser 102 in accordance with embodiments of the present disclosure. In accordance with exemplary embodiments, the laser system 100 may comprise a seed laser 102, a Raman laser 104, an isolator 120, a beam splitter 122, a PM VLMA amplifier 106, and/or the like. In exemplary embodiments, the system 100 may also comprise a first lens 128, an long-pass filter (LPF) 130, a flip mirror 132, a second lens 134, a periodically poled lithium niobite (PPLN) fan-out 136, a third lens 138, an short-pass (SP) filter 140, a second mirror 142, and/or the like. The light-amplification mechanism of a Raman laser 104 may be stimulated Raman scattering. In accordance with exemplary embodiments, a Raman laser 104 may provide output at 1480 nm, or the like. The Raman laser 104 may comprise a cascaded Raman resonator 116 and ytterbium (Yb) fiber laser cavity 118, or the like.

In accordance with exemplary embodiments, the seed laser 102 may comprise a semiconductor saturable absorber mirror (SESAM) 110, a pump diode 112; polarization maintaining erbium doped fibers (PM Er fiber) 108; a splitter 113; and wavelength division multiplexers (WDM) 114. Generally, a SESAM 110 is a nonlinear mirror inserted inside the laser cavity. Its reflectivity is higher at higher light intensities due to absorption bleaching obtained by using semiconductors as the nonlinear material. A SESAM 110 may comprise a bottom mirror and a saturable absorber structure. A SESAM 110 may also comprise a spacer layer and/or an additional antireflection or reflecting coating on the top surface, or the like.

The laser setups shown in FIG. 1A and FIG. 1B differ by the composition of the PM VLMA Amplifiers 106, 107. In the exemplary laser system 100 shown in FIG. 1A, the PM VLMA amplifier 106 may comprise a WDM 123, a PM Er VLMA fiber 124, and a PM VLMA Fiber 126, or the like. In contrast, in the laser system 200 shown in FIG. 1B, the PM VLMA Amplifier 107 may comprise a WDM 129, a PM Er VLMA fiber 131, a spiraled PM VLMA 127, and/or the like. The various components within each of FIG. 1A and FIG. 1B and the other embodiments described herein may be directly or indirectly connected in a communicative, electrical, or non-electrical scheme.

The laser setups shown in both FIG. 1A and FIG. 1B may comprise an erbium-doped polarization-maintaining very large mode area (Er-doped PM VLMA) fiber 124, 131. In some embodiments, the Er-doped PM VLMA fiber 124, 131 may be 3 m long, or a suitable length consistent with the embodiments of the present disclosure. The Er-doped PM VLMA fiber 124, 131 may have an Er absorption of 50 dB/m at 1530 nm and a core diameter of 50 μm, or the like. In some embodiments, the PM VLMA fiber 126, 127 may be coiled to 25 cm diameter resulting in an effective area of approximately 950 μm², or the like. The amplifier 106, 107 may be core pumped by a non-PM Raman fiber laser 104 with up to 50 W single mode output at 1480 nm, so both signal and pump laser are propagation in the fundamental mode with high overlap preventing higher order modes (HOMs) to appear due to differential gain. Especially for ultrashort pulses, the effect of core pumping helps to keep the gain fiber short compared to cladding pumping and thus decreasing nonlinear effects even more.

In accordance with exemplary embodiments, a laser setup of an all PM fiber mode-locked seed laser 102 with pre-amplifier followed by a PM VLMA fiber amplifier 106, 107 core pumped with a 1480 nm Raman laser system 104 is shown in FIG. 1A and FIG. 1B. The output can easily be switched from the fundamental soliton spectral range (1.6 μm to 2 μm) to the second harmonic output ranging from 800 nm up to 1000 nm. According to this embodiment, the passive PM VLMA fiber 126 may have a length of 15 m and may be used to support the spectral shift further to longer wavelength

Referring now to FIG. 1B, a block diagram illustrates a laser system 107 comprising an all PM fiber mode-locked seed laser 102 in accordance with embodiments of the present disclosure. In exemplary embodiments, an all PM fiber mode-locked seed laser 102 with pre-amplifier may be followed by a PM VLMA fiber amplifier 106 core pumped with a 1480 nm Raman laser system 104. The output can easily be switched from the fundamental soliton spectral range (1.6 μm to 2 μm) to the second harmonic output ranging from 800 nm up to 1000 nm. According to this embodiment, the passive PM VLMA fiber 127 may have a length of 15 m and may be coiled by a specially designed spiral from 25 cm down to 6 cm. The spiral may have an effect on the coil diameter and thus causes a slowly decreasing mode field area of the fiber.

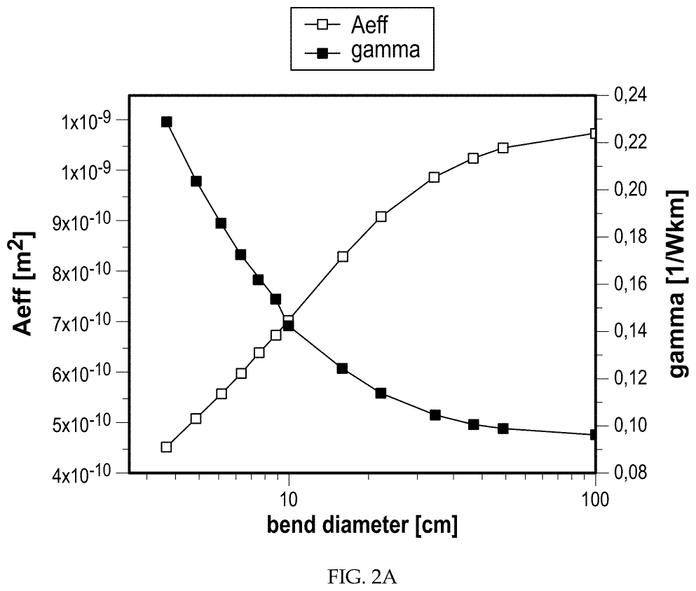

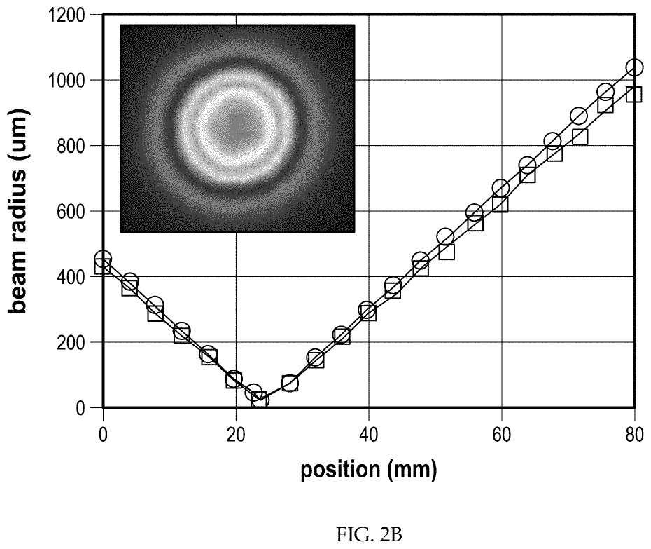

Referring now to FIG. 2A, a chart is shown illustrating a relationship between bend diameter, effective area (Aeff), and nonlinear parameter (gamma) in accordance with embodiments of the present disclosure. A straightened fiber represents an effective area for the fundamental mode of approximately 1050 μm² whereas a coil of 25 cm reduces the effective area down to 950 μm². In accordance with exemplary embodiments, this increases the nonlinearity of the fiber with decreasing gamma during the propagation length. The permanently increased fiber nonlinearity prevents the slow-down of the soliton self-frequency shift caused by loss of peak power and bandwidth during the propagation through the passive PM VLMA. FIG. 2A further illustrates that the bend diameter of the fiber reduces the Aeff while the nonlinear parameter is decreasing that results in an increased nonlinearity of the fiber during propagation through the spiraled fiber coil.

Referring now to FIG. 2B, a chart illustrating the spectral tuning of output by variation of 1480 nm pump power in accordance with embodiments of the present disclosure is shown. A beam profile of the soliton output and M2 measurement, Mx²=1,10; My²=1,06. In accordance with exemplary embodiments, the beam profile may be measured with a phosphor coated CCD camera at 1.4 W average power and λ=1680 nm wavelength. Mx² may be 1.10 and My² may be 1.06 corresponding to an average M² of 1.08. The M² value does not change significantly of the tuning range. According to the exemplary embodiments described herein, there is no indication of modal instabilities over the range of operation.

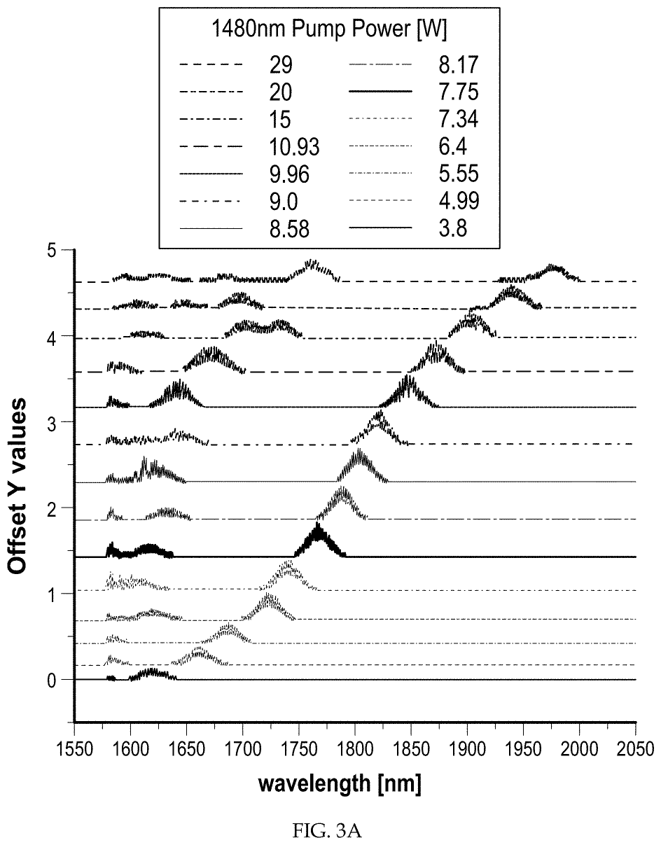

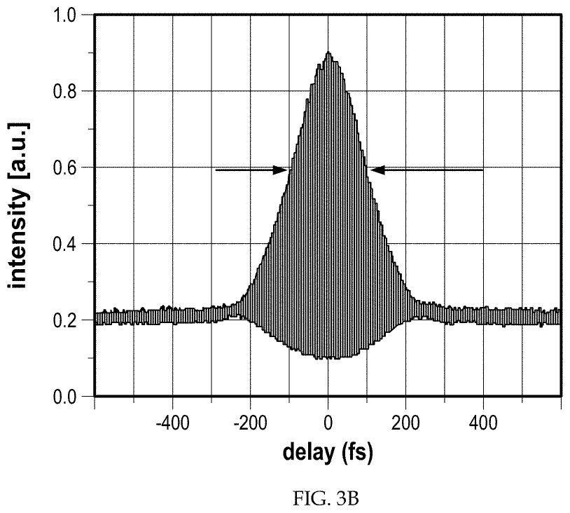

The tunable output passes a collimation lens (f=15.3 mm) resulting in a beam diameter of ˜1 mm (1/e²) depending on the wavelength. A long pass filter (Semrock BLP01-1550R) inserted in the beam path may be configured to cut off the fundamental and the pump laser spectrum. The spectral tuning of the output may be achieved by changing the pump power of the 1480 nm Raman laser, which can easily be done by variation of the pump current (see, e.g., FIG. 3). During the whole tuning process, textbook-like interferometric autocorrelation traces were obtained with pulse widths always in the range of 120 fs (sech²).

Referring now to FIG. 3A, a chart is shown illustrating the spectral tuning of output by variation of 1480 nm pump power in accordance with embodiments of the present disclosure. More specifically, the chart illustrates the spectral tuning of the output from 1618 nm up to 1985 nm by variation of the 1480 nm pump power. Referring to FIG. 3B, a typical autocorrelation trace of the infrared output at 1800 nm with 116 fs (sech²) pulse width is shown. The interferometric autocorrelation shows no pedestals, and the pulse energy is 18 nJ.

As demonstrated by the charts in FIG. 3A and FIG. 3B, by swapping the flip-mirror into the setup, the output can be changed from the tunable infrared spectrum to the second harmonic (SHG) near-infrared output. In that configuration, the beam may be focused through a lens (f=36 mm) into a periodically 5 mol. % MgO doped periodically poled lithium niobate crystal (PPLN) with a fan-out structure. The PPLN fan-out crystal may have a quasi-phase-matching poling period (QPM) starting from 19.5 μm to 34 μm and thus covering a fundamental spectrum from 1550 nm to 2350 nm. The PPLN crystal may comprise a thickness of 0.5 mm in order to maintain acceptance bandwidth and generate a short pulse width of the second harmonic output. The crystal may be mounted on a motorized slide to move it horizontally through the focus in order to match the QPM position of the fan out structure to the fundamental wavelength. Using a f=36 mm lens to collimate the beam after the crystal, a short pass filter may be subsequently introduced to block the residual fundamental spectrum from the second harmonic output.

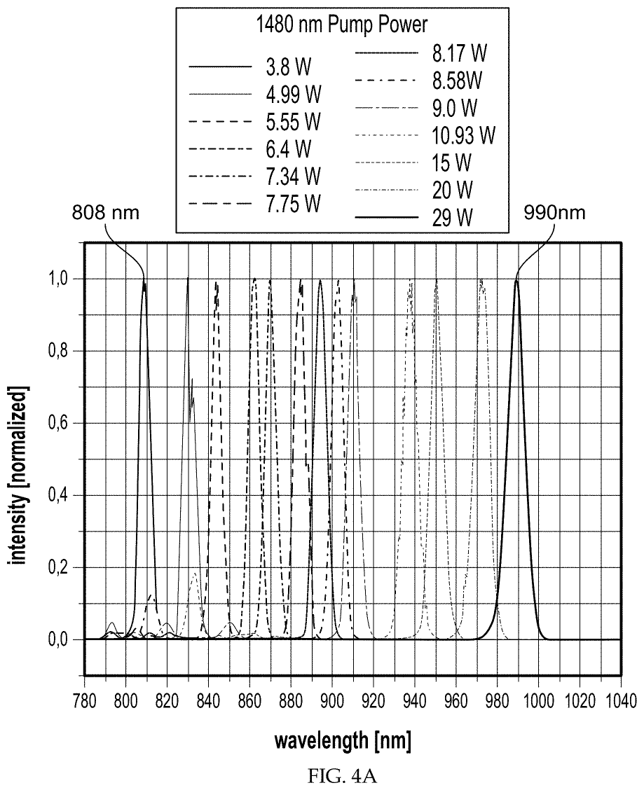

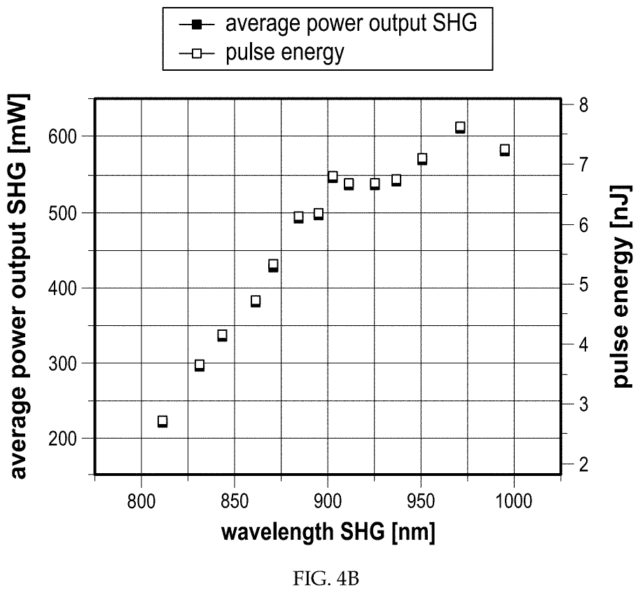

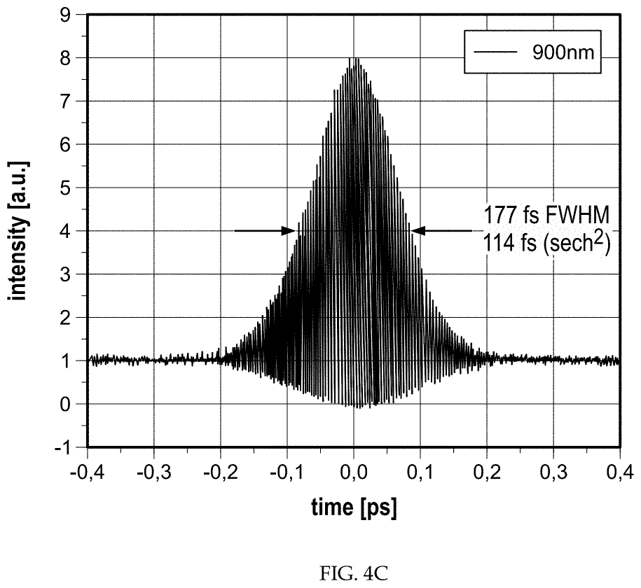

FIGS. 4A-4C show the tuning characteristics of the SHG output in accordance with exemplary embodiments. FIG. 4A is a chart illustrating spectral tuning of the Second Harmonic Generation (SHG) output by variation of the pump power in accordance with embodiments of the present disclosure. Specifically, FIG. 4A illustrates the spectral tuning of the SHG output from 808 nm up to 990 nm by variation of the 1480 nm pump power.

Referring now to FIG. 4B, a chart illustrating average output power and pulse energy in relation to spectral tuning wavelength in accordance with embodiments of the present disclosure is shown. FIG. 4C is a chart illustrating autocorrelation trace of Second Harmonic Generation (SHG) output in accordance with embodiments of the present disclosure. More specifically, FIG. 4C shows an autocorrelation trace of the SHG output at 900 nm with 114 fs (sech²) pulse width. In accordance with exemplary embodiments, the interferometric autocorrelation shows no pedestal and the pulse energy is 6.8 nJ.

A laser system in accordance with embodiments of the present disclosure may be used for multimodal microscopy, and the like. The exemplary embodiments described herein demonstrate the versatility of the PM VLMA laser system for nonlinear microscopy by imaging various biological samples with high 3D resolution. In accordance with a multimodal approach of the present disclosure, two photon-excited fluorescence (TPEF), Second-Harmonic-Generation (SHG), Third-Harmonic-Generation (THG) and spectrally focused Coherent-Anti-Stokes-Raman-Scattering (SF-CARS) may be employed as contrast mechanisms. Whereas TPEF relies on exogenous markers, the other coherent techniques may be label-free and may not suffer from bleaching effects, artifacts introduced by artificial labels and cumbersome sample preparation. However, for an improved signal to noise ratio (SNR) due to phase matching in the forward direction, the detection of the coherent signals may be placed opposite to the focusing objective except for SHG, wherein collection may occur in both directions.

A PM VLMA system in accordance with embodiments of the present disclosure may cover a wide spectral range that enables the excitation of all common markers, including fluorescent proteins. Tuning the wavelength for optimal excitation may show very little changes in the beam path as only the fan-out crystal is moved. For demonstration of TPEF, three different fluorophores may be used covering the whole blue to red spectral range.

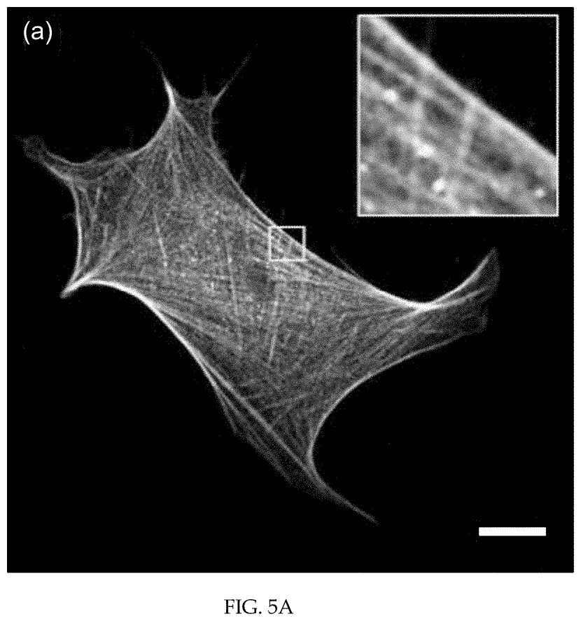

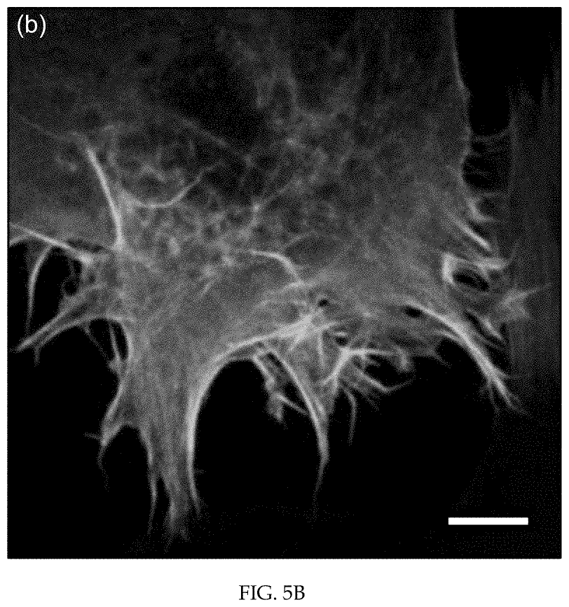

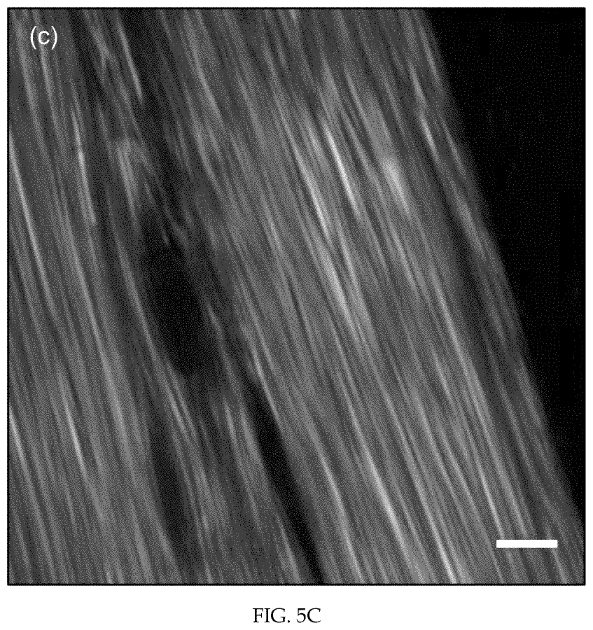

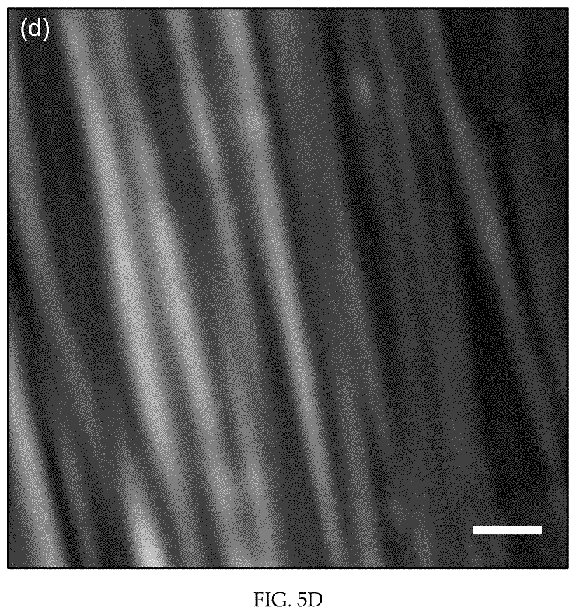

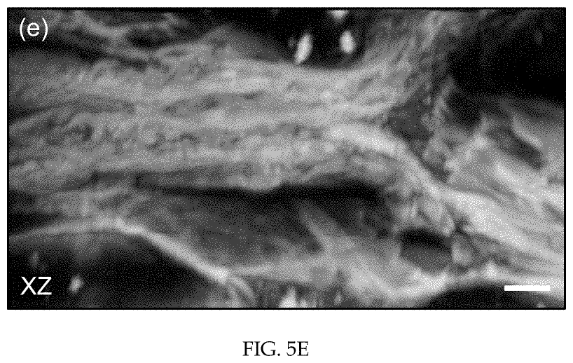

FIGS. 5A-5E show an exemplary application of the PM VLMA laser system in accordance with exemplary embodiments of the present disclosure. FIG. 5A shows a captured image of immunostained fibroblasts actin cytoskeleton and myosin. More specifically, a single NIH3T3 mouse fibroblast cell with immunostained actin using ATTO425 and immunostained myosin using AlexaFluor594 following standard fluorescence labeling protocols is shown. FIG. 5A shows a multi-color TPEF image of immunostained fibroblasts actin cytoskeleton and myosin. The inset shown in a white box in FIG. 5A is a magnified region that reveals the organization of the myosin in respect to the actin in high resolution.

FIG. 5B shows an image of TPEF of actin at Lifeact green fluorescent protein (GFP) transfected fibroblasts employing 2C2P captured in accordance with embodiments of the present disclosure. FIG. 5C shows a second-harmonic generation (SHG) image of mouse tendon collagen fibrils with the forward detected signal and backward detected signal captured in accordance with embodiments of the present disclosure. FIG. 5D shows a second-harmonic generation (SHG) image of organization of fibrils in high resolution without staining. FIG. 5 E shows a third harmonic generation (THG) image of mouse fat tissue excited at 1620 nm, captured in accordance with embodiments of the present disclosure. In FIG. 5E, an XZ projection shows the boundaries of lipid droplets in the fat tissue over 55 μm in depth. The scalebar in FIGS. 5A-5C and E is 10 μm and in FIG. 5D is 1 μm. The NIH3T3 fibroblasts were transfected with Lifeact-green fluorescent protein (GFP) binding on actin and shown in FIG. 5B.

In accordance with exemplary embodiments, SHG may be applied on tendon collagen fibrils of a 58 weeks old C57BL/6 mouse (See FIG. 5C and FIG. 5D). FIG. 5E shows a THG image in the XZ plane on C57BL/6 mouse fat tissue using the fundamental wavelength 1620 nm instead of the SHG output. FIG. 5E may be imaged 55 μm into depth. As THG is sensitive to changes of the nonlinear refractive index, it can be used for imaging boundaries of lipid droplets. Notably, the SHG and THG tissue sections may be prepared directly on the cover slips without extra staining procedures. Spectral focusing (SF) Coherent anti-Stokes Raman spectroscopy (CARS) is another example embodiment of a multimodal imaging approach of the present disclosure. Based on Raman scattering, it is chemically specific in the vibrational fingerprint region of a molecule. CARS may rely on two laser pulses with different center frequencies and may strongly be enhanced, if the frequency difference is tuned to match a vibrational mode of the molecule of interest.

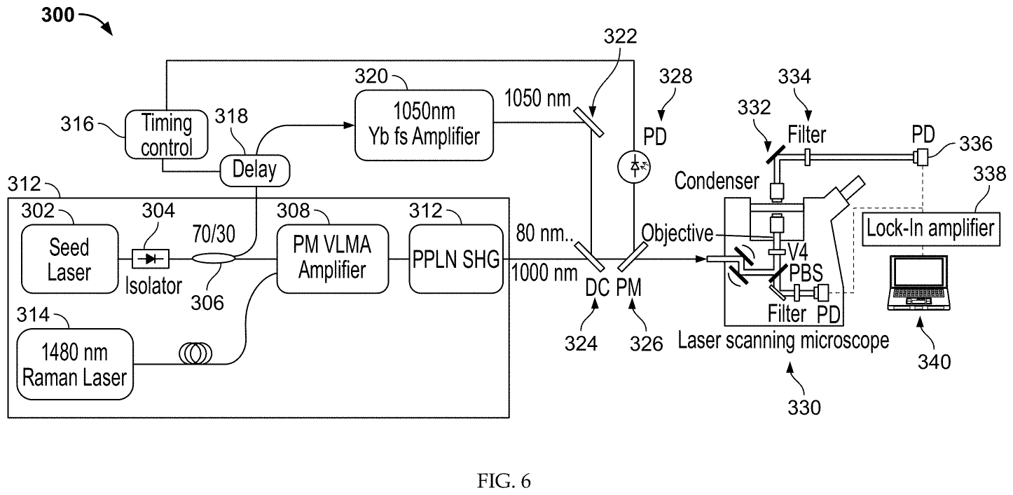

Referring now to FIG. 6, a block diagram illustrating a Coherent anti-Stokes Raman spectroscopy (CARS) laser system 300 in accordance with embodiments of the present disclosure is shown. For the CARS system 300, a PM VLMA laser system 310 may be extended with a Yb-doped fiber femtosecond (Yb-fs) amplifier 320 working at 1050 nm, or the like. FIG. 6 illustrates an exemplary CARS laser setup 300 including the PM VLMA laser system 310 and a 1050 nm Yb fs amplifier system 320 seeded through the 70% seed laser output. In accordance with exemplary embodiments, the PM VLMA laser system 310 may comprise a seed laser 302 and a Raman laser 314, followed by an isolator 304, a beam splitter 306, a PM VLMA amplifier 308, and a Periodically Poled Lithium Niobate (PPLN) Second-harmonic generation (SHG) 312. Both outputs may be combined by the dichroic mirror DC 324 followed by the pickup mirror PM 326 and the Photodetector PD 328 used to measure the pulse delay between the Stokes and the pump laser. The delay control 318 may be used to synchronize the two pulses at the microscope focal plane.

The CARS system 300 may also comprise a timing control 316, a delay 318, a Yb fs Amplifier 320, a mirror 322, a dichroic mirror DC 324, a pickup mirror PM 326, and a Photodetector PD 328. The CARS system 300 may also comprise a laser scanning microscope 330, a mirror 332, a filter 334, a second photodetector 336, a lock-in amplifier 338, and a computing device 340, or the like. The computing device 340 may be configured to control the operation of the laser scanning microscope 330 and the laser system 310, or the like, and may be configured to display images captured therefrom. In some embodiments, the computing device may comprise at least a processor, an input device, an output device, and a display configured and adapted to control the microscope 330 and the laser system 310 and display data and images captured therefrom, or the like.

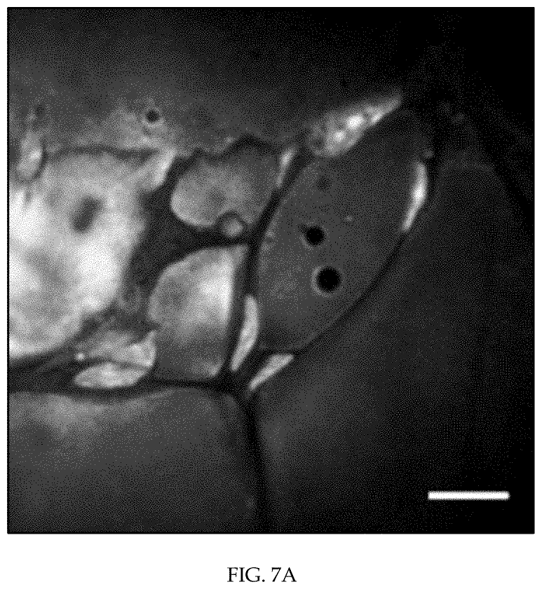

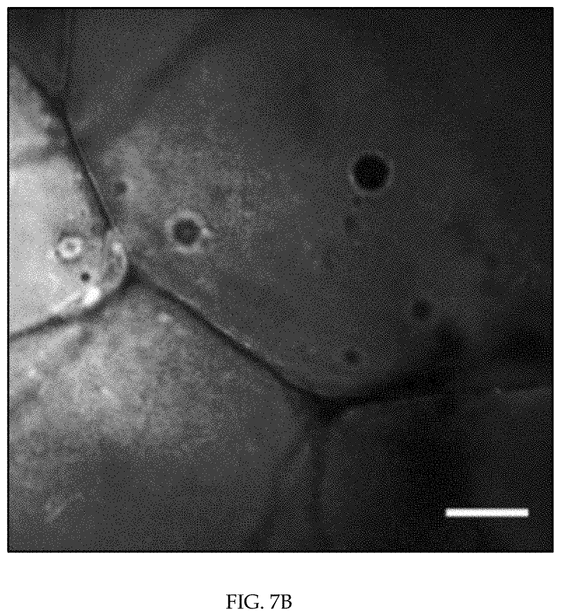

In accordance with exemplary embodiments, an amplifier 320 may be seeded with the 70% output of an 80 MHz oscillator and may generate an output of up to 3 W average power with about 100 fs (sech²) pulse width, or the like. The spectral width of the output may be 10 nm full width at half maximum (FWHM) providing almost bandwidth limited pulses centered at 1050 nm. For improving the spectral selectivity in CARS, the exemplary embodiments may apply grating stretchers to each of the two laser pulses making use of the spectral focusing technique. Accordingly, mouse fat tissue may be imaged probing the aliphatic C—H2 band at 2850 cm-1 and counterstained the cell nuclei with DAPI for TPEF imaging, as shown in FIG. 7.

FIG. 7A and FIG. 7B show a Sum Frequency Coherent anti-Stokes Raman spectroscopy (SF-CARS) image of mouse fat tissue captured in accordance with embodiments of the present disclosure. In exemplary embodiments, lipid droplets may be imaged with SF-CARS probing at 2850 cm-1, or the like. Cell nuclei may be stained with DAPI (blue) and imaged with TPEF. In FIG. 7, the scalebar is 10 μm. For synchronization of the laser pulses, a two-stage timing delay may be implemented into the output branch seeding the 1050 nm Yb amplifier. This module may comprise a fiber pigtailed mechanical delay stage for coarse tuning and a fiber coil delay stage based on thermal tuning of a spool of 30 cm PM 980 fiber. The synchronized pulses can not only be used for CARS, but they may enable 2C2P excitation. For example, a green fluorescent protein may be either excited by simultaneous absorption of two 920 nm photons or by the sum of one 820 nm and another 1050 nm photon. This 2C2P excitation corresponding to a virtual two-photon wavelength of 920 nm is demonstrated in FIG. 5B and may have the advantage that in principle, three wavelengths are simultaneously present for excitation of different fluorophores.

The exemplary embodiments described herein showed an all-fiber versatile laser system ideally fitting to the needs of multimodal imaging in nonlinear microscopy. The embodiments disclosed herein show a large spectral coverage over 370 nm starting from 1620 nm to 1990 nm in combination with a high pulse energy of up to 6.8 nJ and a 120 fs pulse length directly out of the fiber. With an additional SHG, the output spectral coverage can be extended with a spectral window starting from 800 nm up to 1 μm and 2.5 nJ pulse energy and 120 fs pulse width. Therefore, embodiments of the present disclosure provide the flexibility to perform SHG, THG, TPEF and SF-CARS, with a simple setup but with excellent results.

In the above disclosure and the claims, terms such as “first”, “second”, “third”, and the like, are used to distinguish similar components from each other and may be used to describe a specific sequence but is not necessarily limited thereto. It will be understood that these terms are compatible with each other under an appropriate environment so that exemplary embodiments of the present disclosure set forth herein may be operated in a sequence different from a sequence illustrated or described herein. Likewise, in the case in which it is described herein that a method includes a series of steps, a sequence of these steps suggested herein is not necessarily a sequence in which these steps may be executed.

Terms used in the present disclosure are for explaining exemplary embodiments rather than limiting the present disclosure. In the present disclosure, a singular form includes a plural form unless explicitly described to the contrary. Components, steps, operations, and/or elements mentioned by terms “comprise” and/or “comprising” used in the disclosure do not exclude the existence or addition of one or more other components, steps, operations, and/or elements.

Hereinabove, the present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. An ultrafast laser system comprising:
an all polarization-maintaining (PM) fiber mode-locked seed laser with a pre-amplifier;
a Raman laser comprising a cascaded Raman resonator and an ytterbium (Yb) fiber laser cavity;
an amplifier core-pumped by the Raman laser, the amplifier comprising an erbium (Er) doped polarization maintaining very large mode area (PM Er VLMA) optical fiber and a passive PM VLMA fiber following the PM Er VLMA, the passive PM VLMA for supporting a spectral shift to a longer wavelength;
wherein the system provides a spectral coverage starting from 1620 nm to 1990 nm.

2. The ultrafast laser system of claim 1, wherein the passive PM VLMA fiber and PM Er VLMA fiber are configured to have the same fundamental mode effective area.

3. The ultrafast laser system of claim 1, wherein the passive PM VLMA is spiraled in a decreasing coil diameter to achieve decreasing effective area along the length of the passive PM VLMA.

4. The ultrafast laser system of claim 1, wherein starting at 1.5 μm, the system is configured to access a wavelength region from 1.6 μm up to 2 μm by soliton self-frequency shifting (SSFS).

5. The ultrafast laser system of claim 1, wherein the system provides a high pulse energy of 6.8 nJ and a 120 fs pulse length.

6. The ultrafast laser system of claim 1, wherein the PM Er VLMA optical fiber is 3 m long with an Er absorption of 50 dB/m at 1530 nm and a core diameter of 50 μm.

7. The ultrafast laser system of claim 1, wherein the amplifier is a master-oscillator-power-amplifier (MOPA).

8. The ultrafast laser system of claim 1, wherein the Raman laser is non-polarization maintaining (PM) and the amplifier is core pumped by the non-PM Raman laser with up to 50 W single mode output at 1480 nm.

9. The ultrafast laser system of claim 8, wherein core pumping maintains the gain fiber and the non-PM Raman laser propagate in the fundamental mode with overlap thereby substantially preventing higher order modes (HOMs) appearing due to differential gain.

10. An ultrafast laser system comprising:
an all polarization-maintaining (PM) fiber mode-locked seed laser with a pre-amplifier;
a 1480 nm Raman laser comprising a cascaded Raman resonator and an ytterbium (Yb) cavity;
an amplifier core-pumped by the Raman laser, the amplifier comprising an erbium (Er) doped polarization maintaining very large mode area (PM Er VLMA) optical fiber and a passive PM VLMA following the PM Er VLMA, the passive PM VLMA coiled to decrease mode field area of the fiber, the amplifier;
wherein the passive PM VLMA fiber and PM Er VLMA fiber are configured to have the same fundamental mode effective area; and
wherein the laser system is configured to switch from a fundamental soliton spectral range of 1.6 μm to 2 μm to a second harmonic output ranging from 800 nm to 1000 nm.

11. The ultrafast laser system of claim 10, wherein the passive PM VLMA is spiraled in a decreasing coil diameter to achieve decreasing effective area along the length of the passive PM VLMA.

12. The ultrafast laser system of claim 10, wherein the system provides a high pulse energy of 6.8 nJ and a 120 fs pulse length.

13. The ultrafast laser system of claim 10, wherein the amplifier is a master-oscillator-power-amplifier (MOPA).

14. The ultrafast laser system of claim 10, wherein the Raman laser is non-polarization maintaining (PM); and
wherein both the seed laser and the non-PM Raman laser propagate in the fundamental mode with overlap thereby substantially preventing higher order modes (HOMs) appearing due to differential gain.

15. An ultrafast laser system comprising:
an all polarization-maintaining (PM) fiber mode-locked seed laser;
a pump laser comprising a cascaded Raman resonator and an ytterbium (Yb) cavity;
a polarization maintaining very large mode area (PM VLMA) amplifier, the amplifier core-pumped by the Raman laser, the amplifier comprising an erbium (Er) doped polarization maintaining very large mode area (PM Er VLMA) optical fiber and a passive PM VLMA fiber following the PM Er VLMA, the passive PM VLMA for supporting a spectral shift to a longer wavelength;
a Ytterbium-doped fiber femtosecond (Yb-fs) amplifier;
a dichroic mirror (DC) followed by a pickup mirror (PM);
a photodetector (PD) for measuring a pulse delay;
a delay control for synchronizing two pulses at a microscope focal plane; and
a laser scanning microscope following the PM; and
wherein the system provides a spectral coverage starting from 1620 nm to 1990 nm.

16. The ultrafast laser system of claim 15, wherein starting at 1.5 μm, the system is configured to access a wavelength region from 1.6 μm up to 2 μm by soliton self-frequency shifting (SSFS) in combination with a master-oscillator-power-amplifier (MOPA) soliton compression amplification.

17. The ultrafast laser system of claim 15, wherein the passive PM VLMA fiber and PM Er VLMA fiber are configured to have the same fundamental mode effective area.

18. The ultrafast laser system of claim 15, wherein the passive PM VLMA is spiraled in a decreasing coil diameter to achieve decreasing effective area along the length of the passive PM VLMA.

19. The ultrafast laser system of claim 15, wherein the pump laser is non-polarization maintaining (PM) and the PM VLMA amplifier is core pumped by the pump laser with up to 50 W single mode output at 1480 nm.

20. The ultrafast laser system of claim 15, wherein both the seed laser and the pump laser propagate in the fundamental mode with overlap thereby substantially preventing higher order modes (HOMs) appearing due to differential gain.
